(19) United States
(12) Patent Application Publication
(10) Pub. No.: US 2013/0153612 A1
(43) Pub. Date: Jun. 20, 2013

(54) Aerodynamic Underbody Spare Tire Cover

(71) Applicants: Timothy F. O'Brien, White Lake, MI (US); Bradley R. Hamilton, Canton, MI (US); Jeffrey B. Manhire, Rochester Hills, MI (US); Anthony J. Povinelli, Romeo, MI (US)

(72) Inventors: Timothy F. O'Brien, White Lake, MI (US); Bradley R. Hamilton, Canton, MI (US); Jeffrey B. Manhire, Rochester Hills, MI (US); Anthony J. Povinelli, Romeo, MI (US)

(73) Assignee: MAGNA INTERNATIONAL INC., Aurora (CA)

(21) Appl. No.: 13/744,813

(22) Filed: Jan. 18, 2013

Related U.S. Application Data
(63) Continuation-in-part of application No. 13/714,655, filed on Dec. 14, 2012.
(60) Provisional application No. 61/576,435, filed on Dec. 16, 2011.

(51) Int. Cl. B62D 43/00

(52) U.S. Cl. CPC B62D 43/005
USPC 224/42.2

(57) ABSTRACT

A spare tire assembly which includes a spare tire or under mount frame, a spare tire, and a cover. The assembly may optionally include an electric winch, and a jack. The cover is connected to the under mount frame when assembled to the vehicle, and is disconnected from the under mount frame when the spare tire is needed. The cover has dimples which improve air flow underneath the vehicle. The cover is made of different sizes to be used with different size spare tires for different types of vehicles, such as trucks, sport utility vehicles, and vans.

### CROSS-REFERENCE TO RELATED APPLICATIONS

This application is a continuation-in-part application of U.S. patent application Ser. No. 13/714,655, Filed Dec. 14, 2012 which claims the benefit of U.S. Provisional Application No. 61/576,435, filed Dec. 16, 2011.

### FIELD OF THE INVENTION

The present invention relates to a modular spare tire cover for a vehicle, where the spare tire cover improves fuel economy by reducing weight and improving aerodynamics.

### BACKGROUND OF THE INVENTION

Spare tires are included with almost every vehicle manufactured today. While most cars have trunk space in which the spare tire is located, other types of vehicles, such as, trucks, sport utility vehicles, and certain types of vans have the spare tire located underneath the vehicle, and attached to the frame through some type of mounting system.

However, the equipment used to stow the spare tire increases the overall weight of the vehicle, and, depending upon the placement of the tire, may also have an effect of the aerodynamics of the vehicle, reducing fuel economy.

Accordingly, there exists a need for equipment used to stow a spare tire which is of a reduced weight, and has a minimal effect on the aerodynamics of the vehicle, improving fuel economy.

### SUMMARY OF THE INVENTION

The present invention is directed to a spare tire which is mounted underneath a vehicle. The spare tire is part of an assembly which includes a spare tire frame, a spare tire, and a cover. The assembly may optionally include an electric winch, and a jack. The cover has dimples which improve air flow underneath the vehicle. The cover is made in different sizes to be used with different size spare tires for different types of vehicles, such as trucks, sport utility vehicles, and vans.

Another embodiment of the invention includes a cover sold separately from the vehicle, and installed by the purchaser or the dealer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a first exploded view of a spare tire and cover assembly, according to a first embodiment of the present invention;

FIG. 2 is a second exploded view of a spare tire and cover assembly, according to a second embodiment of the present invention;

FIG. 3 is a first exploded view of a spare tire and cover assembly, according to a second embodiment of the present invention;

FIG. 4 is a second exploded view of a spare tire and cover assembly, according to a second embodiment of the present invention;

FIG. 5 is a bottom view of the spare tire and cover assembly in accordance with the present invention;

FIG. 6a is a cross-sectional side view of the spare tire and cover assembly connected to a vehicle with the spare tire in the stowed position;

FIG. 6b is a cross-sectional side view of the spare tire and cover assembly connected to a vehicle with the spare tire in the stored position;

FIG. 7 is a perspective side view of the spare tire and cover assembly connected to a vehicle frame in accordance with the first embodiment of the invention;

FIG. 8 is a perspective side view of the spare tire and cover assembly connected to a vehicle frame in accordance with the third embodiment of the invention;

FIG. 9. is a perspective side view of the spare tire and cover assembly connected to a vehicle frame in accordance with the fourth embodiment of the invention; and

FIG. 10 is an exploded side perspective view of the spare tire and cover assembly in accordance with the fourth embodiment of the invention showing a fairing flange connection with the rear bumper of the vehicle.

### DETAILED DESCRIPTION OF THE PREFERRED EMBODIMENTS

The following description of the preferred embodiment(s) is merely exemplary in nature and is in no way intended to limit the invention, its application, or uses.

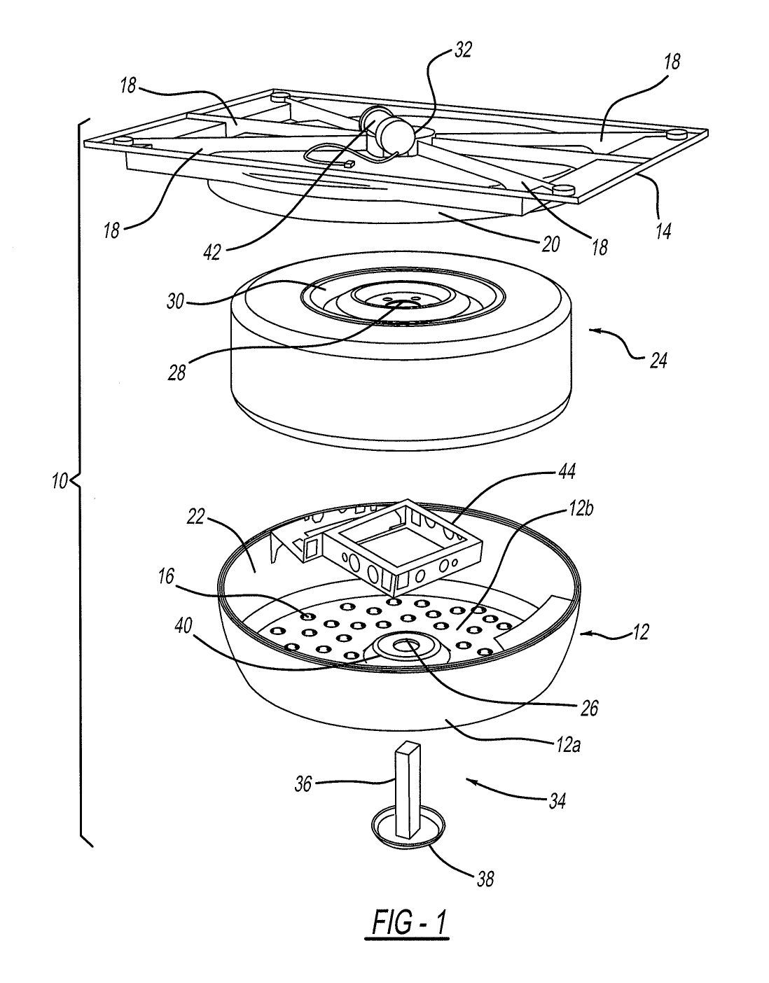

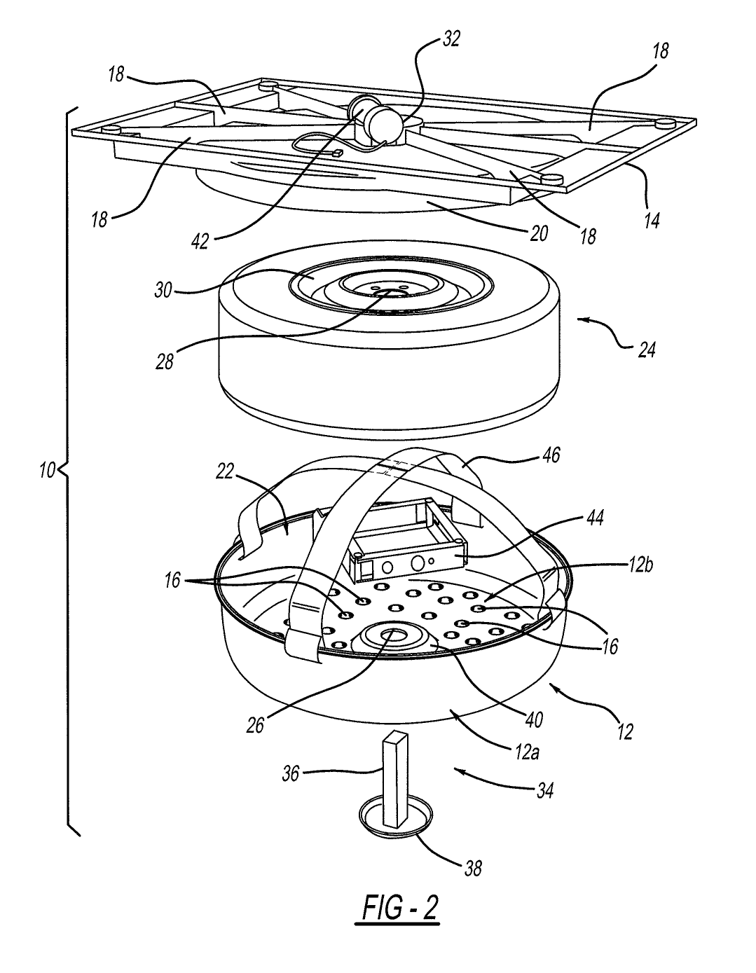

An embodiment of an aerodynamic underbody spare tire assembly is shown in the FIGS. 1-2 generally at 10. The assembly 10 is used for storing a spare tire underneath a vehicle, while improving fuel economy by improving air flow underneath the vehicle and reducing the weight of the vehicle. The assembly 10 includes a cover 12, and an under mount frame 14. The cover 12 is generally hemispherical in shape, and includes several detents, or “dimples” 16. The dimples 16 are also generally hemispherical in shape, and improve air flow underneath the vehicle, reducing wind drag and therefore improving fuel economy.

The frame 14 is attached underneath the vehicle, and may be connected to the vehicle frame, or molded as part of the vehicle frame. The frame 14 includes several cross members 18, which provide the frame 14 with added strength. The frame 14 also includes an outer lip 20 which corresponds to the shape of the cover 12, and when the cover 12 is connected to the frame 14, the interior cavity, shown generally at 22, of the cover 12 is closed off from the outside environment, keeping a spare tire, shown generally at 24, protected from exposure to the outside environment. In the embodiment shown the outer lip 20 goes around the circumference of the cover 12. However, it is also within the scope of the present invention to have the cover 12 fit outside the outer circumference of outer lip 20. The assembly 10 is operable to be changed between a stowed position, where the tire 24 and cover 12 are assembled to the vehicle, and a deployed position, where the tire 24 and cover 12 are detached from the frame 14, and the tire 24 is used to replace a flat tire.

Integrally formed with the cover 12 is a side wall 12a for extending around the outer periphery of a spare tire and a circular portion 12b attached to the side wall 12a for forming a continuous outer aerodynamic housing encompassing the entire tire 24 within the cover 12. Also, side wall 12a and circular portion 12b define the interior cavity 22. A lower aperture 26, which is in substantial alignment with an aperture 28 formed as part of the rim 30 of the tire 24. The lower aperture 26 is also in substantial alignment with an upper aperture 32 formed as part of the frame 14. When the assembly 10 is in the stowed position, a support member, shown generally at 34, extends through each of the apertures 26,28,32. More specifically, the support member 34 includes a post member 36 and a plate member 38, where the plate member 38 is substantially circular in shape. The plate member 38 is approximately the same diameter as an indented portion 40 formed as part of the cover 12, and the aperture 26 is formed as part of the indented portion 40.

The spare tire assembly 10 optionally may include a tire jack 44 connected to the assembly 10. In one embodiment of the invention, the tire jack 44 is placed between the cover 12 and the tire 24.

Mounted to the frame 14 is an actuator, which in this embodiment is an electric winch 42, the electric winch 42 includes a cable (not shown) which extends through the upper aperture 32, the aperture 28, through the tire jack 44, and the lower aperture 26 and selectively connects to the post member 36. When it is desired to stow the tire 24 underneath the vehicle, the cable is connected to the post member 36 and the winch 42 is activated to pull on the cable, and therefore pull the cable toward and the support member 34 toward the frame 14. As this occurs, the post member 36 is pulled through the lower aperture 26, the tire jack 44, the aperture 28, and through the upper aperture 32, and the plate member 38 is received by the indented portion 40. The post member 36 is substantially rigid, and keeps the various components of the assembly from moving and shifting when the assembly 10 is attached to the vehicle.

If the spare tire 24 is needed, the winch 42 is activated to loosen the cable, and allow the support member 34 to move away from the frame 14. The winch 42 may be connected electronically to a switch inside the vehicle or at some other location on the vehicle. As the support member 34 is lowered, the cover 12, jack 44, and tire 24 are lowered as well. Once the support member 34 is lowered enough, and there is enough slack in the cable, the cable is detached from the post member 36, allowing the spare tire 24 and the jack 44 to be removed from the cover 12.

When the assembly 10 is attached to the vehicle, the dimples 16 improve the airflow underneath the vehicle, improving fuel economy. Additionally, the cover 12, frame 14, and support member 34 are made of a lightweight composite material, reducing the overall weight of the vehicle, further improving fuel economy. Preferably, the material used is a recycled thermoplastic material derived from regrinds from automotive part productions. In other embodiments, the cover 12 is made of different sizes to be used with different size tires.

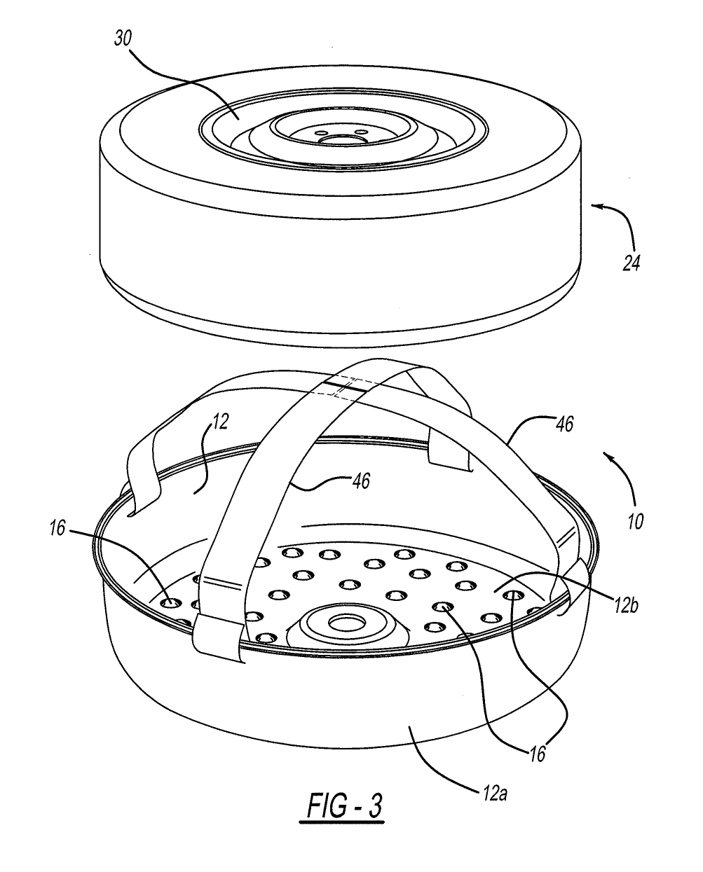

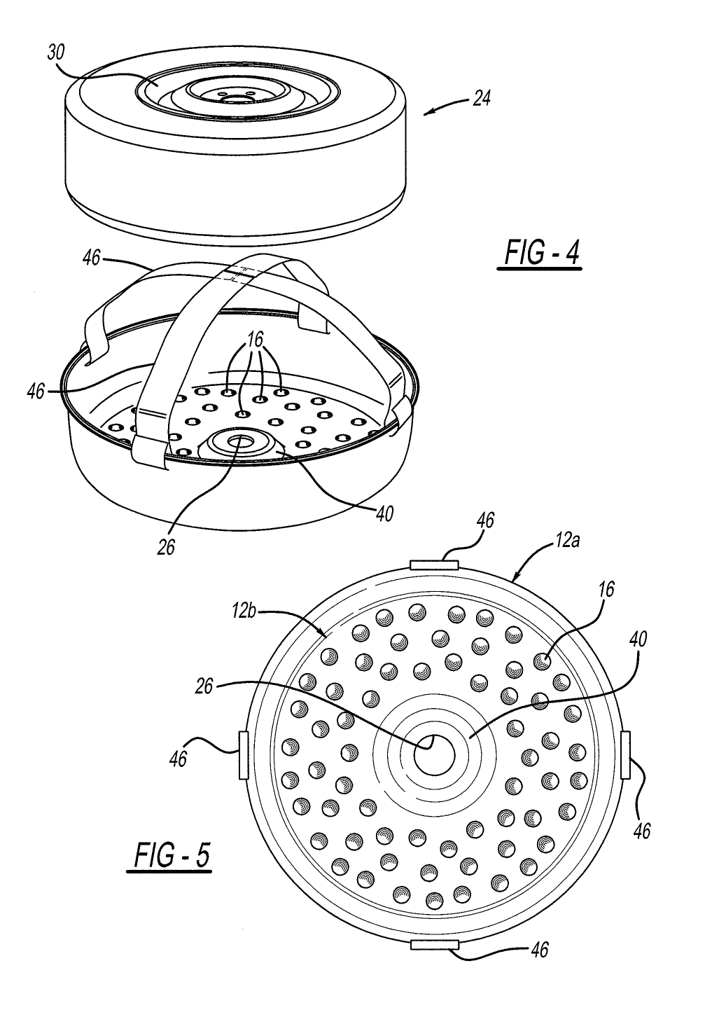

A second embodiment of the present invention is shown in FIGS. 2-4, with like numbers referring to like elements. In this embodiment, instead of the support member 34 and the winch 42, there is a plurality of straps 46; more specifically, there are two straps 46 attached to the cover 12. The straps 46 secure the tire 24 in the cover 12, and also are used to secure the cover 12 to the vehicle. The embodiment shown in FIGS. 3-4 may be sold separately from the vehicle, such as an aftermarket product. The second embodiment also includes the dimples 16 for improving airflow underneath the vehicle, reducing wind drag, and improving fuel economy. Alternatively, in addition to providing dimples aeorodynamically enhancing surfaces or coatings are used for additional reduction in losses due to wind drag on the housing. For instance Sharklet™ materials or surface treatments are used on the exposed surface of the housing. Sharklet™ film materials are available from Sharklet Technologies, Inc. Aurora Colo. Alternatively, aerodynamic surface treatment patterns and/or micro topogrophies, such as shown in U.S. Pat. No. 7,143,709 B2 to Brennan et al. (the disclosure of which is hereby incorporated herein by reference), are formed in the mold used to manufacture the cover such that the molded cover includes an aerodynamically enhanced surface which is used to reduce the surface drag of the cover.

If desired, the straps 46 may also optionally be incorporated into the first embodiment, shown in FIG. 2, to allow the spare tire 24 and cover 12 to be removed from the vehicle and carried from one location to the next. Suitable handles for carrying of the tire may also be molded in the cover if desired.

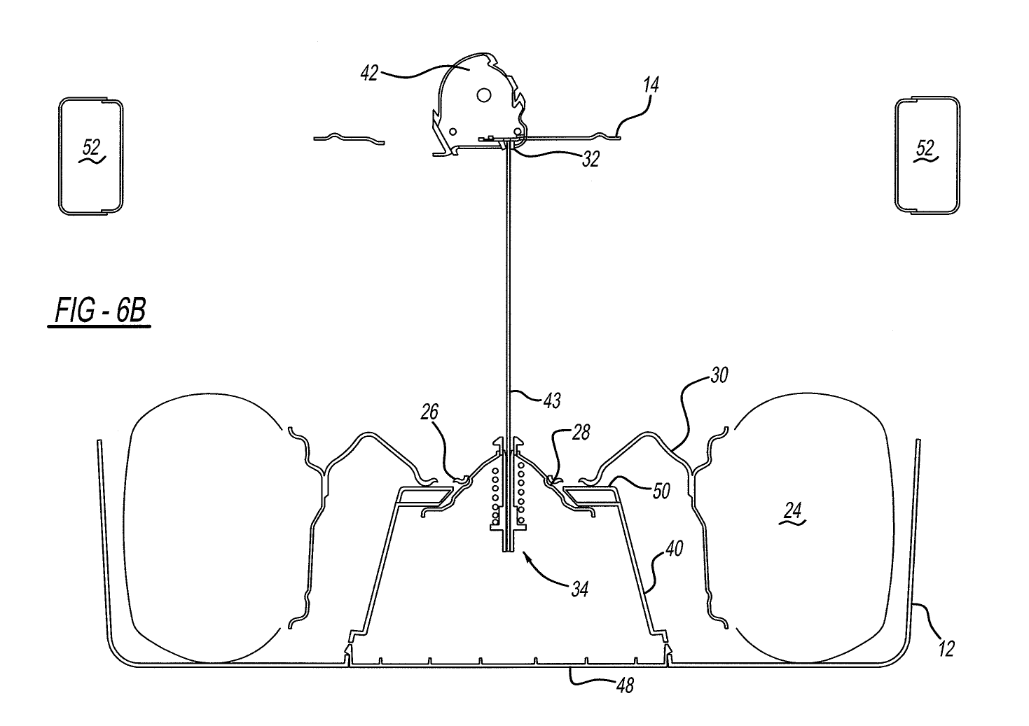

FIG. 6a shows a cross-sectional side view of the spare tire assembly 10 in the stowed position, while FIG. 6b shows the spare tire assembly 10 in the deployed position in accordance with all embodiments of the present invention. The support member 34 contacts stand-offs 50 formed in the indented portion 40 of the cover 12. The stand-offs 50 function to transition the various aperture sizes of the aperture 28 of the rim and the lower aperture 26 of the indented portion 40. This permits the indented portion 40 of the cover to be used with various sized apertures 28 of various rims 30.

In order to make the outer surface of the cover 12 more aerodynamic, a center cover 48 snaps into place in order to cover the hollow area of the indented portion 40, where the support member 34 contacts the indented portion 40 and aperture 28 of the rim 30. When the tire 34 is to be removed from the cover 12, the center cover 48 can be removed allowing access to the support member 34 in order to disconnect the support member 34 from the rim 30 of the tire 24.

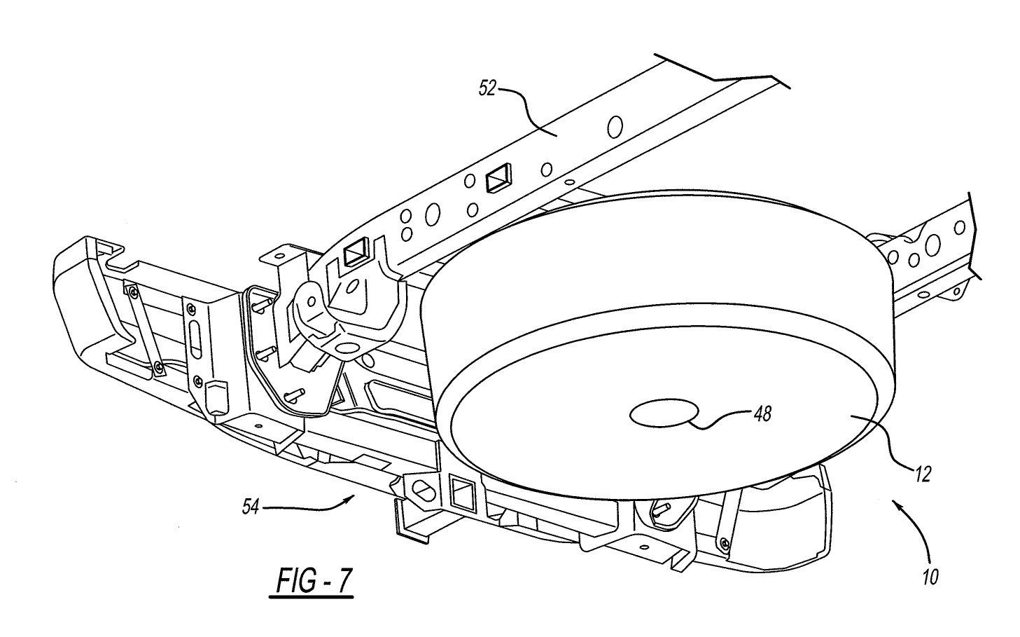

FIG. 7 shows a bottom perspective view of the spare tire assembly 10 connected to the bottom of a vehicle frame 52. Connected to the back side of the vehicle frame 52 is a bumper 54. The cover 12 as shown in FIG. 7 is in the stowed position and contains the tire 24. The center cover 48 is visible and can be connected to and removed from the cover 12 using snap fittings.

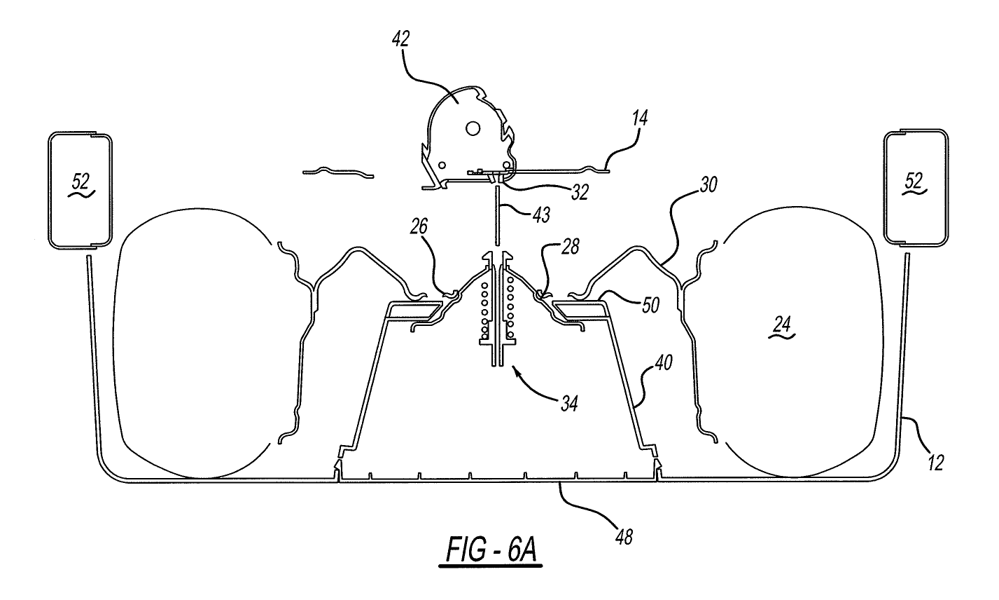

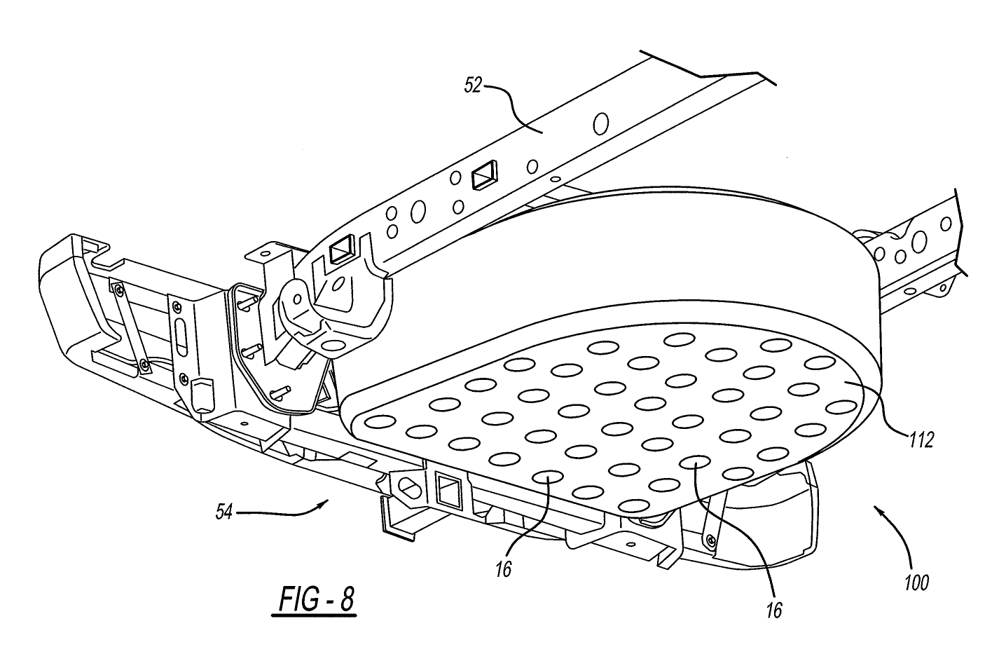

FIG. 8 shows an alternate embodiment of a spare tire assembly 100. Like reference numerals of other structures shown in FIGS. 1-7 appear on FIG. 8. In this particular embodiment of the invention, a cover 112 is a square-sided cover, instead of being a round cover. The cover 112 in this embodiment is a D-shaped cover for improving airflow. The square-sided cover 112 covers more space between the bumper 54 and the square-sided cover 112 in order to prevent airflow between the square-sided cover 112 and the bumper 54. The square-sided cover 112 optionally also includes dimples 16 to improve the aerodynamic airflow under the vehicle.

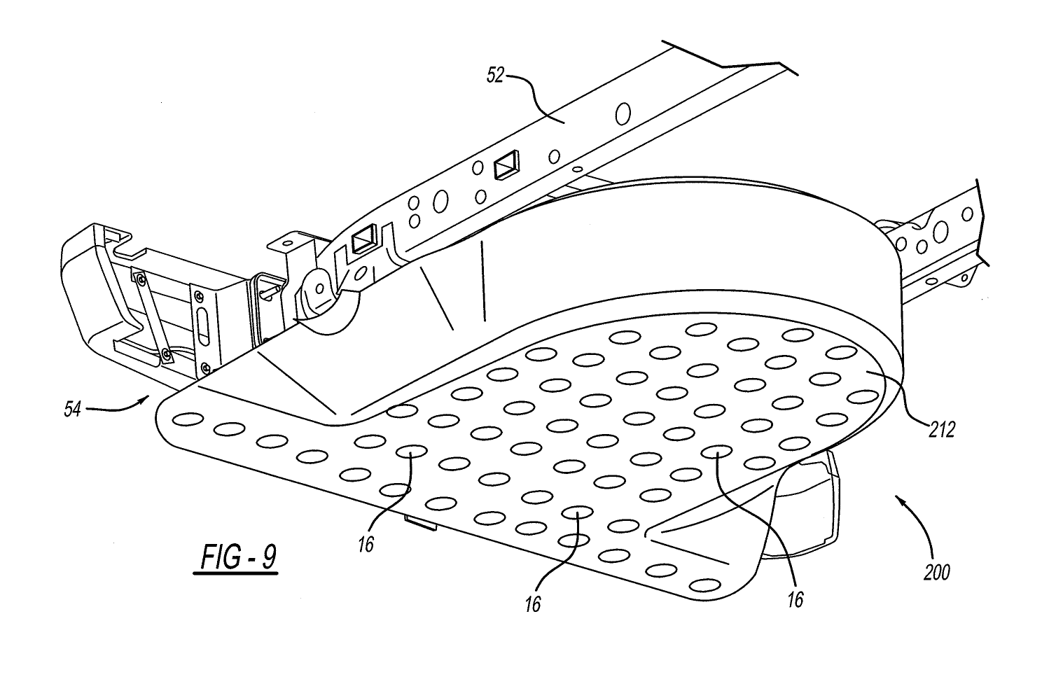

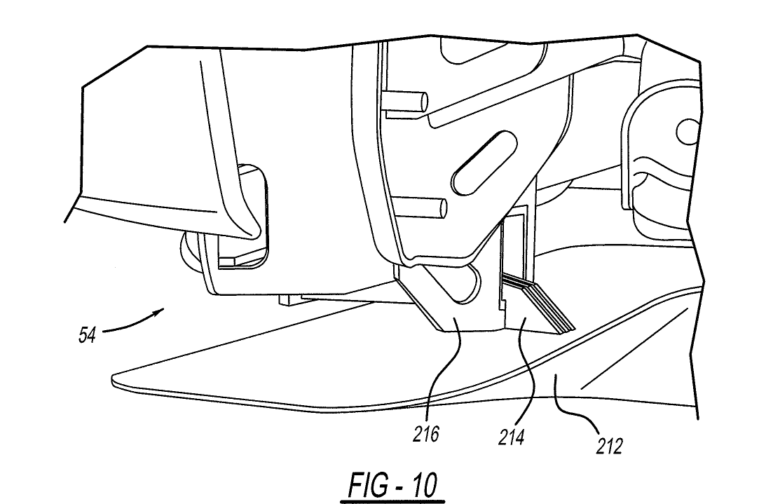

FIG. 9 shows another alternate embodiment of the spare tire assembly 200. Reference numerals common with the other Figures have been retained to show same structures in FIG. 9. The spare tire assembly 200 in this particular embodiment of the invention includes a fairing cover 212 that extends over the bottom part of the bumper 54 in order to prevent any airflow on the underside of the vehicle between the fairing cover 212, the vehicle frame 52 and the bumper 54. The fairing cover 212 also optionally includes aerodynamic dimples 16 for improving airflow on the underside of the vehicle. FIG. 10 shows an exploded side perspective view of the fairing cover 212 embodiment showing a fairing flange 214 connecting to a bumper flange 216 of the bumper 54. The fairing cover 212 has a portion that extends over a portion of the bottom side of the bumper 54. In some embodiments it is desired to provide a fairing flange 214 connectable with a bumper flange 216 in order to support the portion of the fairing cover 216 that extends under the bumper 54. The embodiment shown in FIG. 9 further provides improved airflow of the spare tire assembly 200 on the underside of the vehicle by providing a more aerodynamic surface that directs airflow around the cover member bumper and portions of the frame to prevent wind drag.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A spare tire assembly for a vehicle, comprising:
an under mount frame connected to a vehicle;
a cover operably connected to said under mount frame;
a spare tire supported by said cover;
an actuator connected to said under mount frame; and
a support member operable with said actuator for securing said cover to said under mount frame.

2. The spare tire assembly for a vehicle of claim 1, further comprising:
a cavity formed as part of said cover;
wherein said spare tire is disposed in said cavity when said cover is attached to said under mount frame.

3. The spare tire assembly for a vehicle of claim 1, further comprising:
a lower aperture formed as part of said cover;
an aperture formed as a rim, said rim being part of said spare tire; and
an upper aperture formed as part of said under mount frame;
wherein at least a portion of said support member extends through said lower aperture, said aperture, and said upper aperture when said cover is attached to said under mount frame.

4. The spare tire assembly for a vehicle of claim 3, said support member further comprising:
a post member operable for extending through said lower aperture, said aperture, and said upper aperture when said cover is attached to said under mount frame; and
a plate member connected to said post member, said plate member in contact with said cover and supporting said cover when said cover is attached to said under mount frame.

5. The spare tire assembly for a vehicle of claim 4, further comprising an indented portion formed as part of said cover, said upper aperture formed as part of said indented portion, and said plate member is received into said indented portion when said cover is attached to said under mount frame.

6. The spare tire assembly for a vehicle of claim 1, further comprising a tire jack disposed between said spare tire and said cover.

7. The spare tire assembly for a vehicle of claim 1, further comprising an aerodynamic surface treatment on the exposed surface of the cover comprising at least one dimple integrally formed as part of said cover, said at least one dimple operable for improving air flow underneath said vehicle.

8. The spare tire assembly for a vehicle of claim 1, said actuator further comprising an electric winch connected to said under mount frame.

9. The spare tire assembly for a vehicle of claim 1 further comprising at least one strap attached to the cover for retaining the cover on the tire.

10. The spare tire assembly for a vehicle of claim 1 further comprising a pair of straps crossing one another for securing the cover onto the spare tire.

11. The spare tire assembly for a vehicle of claim 1 wherein the cover is made of a recycled polymer material

12. The spare tire assembly for a vehicle of claim 1 wherein the surface of the cover includes an aerodynamically enhanced surface comprising and integrally molded surface topography for reducing air drag moving across the cover.

13. The spare tire assembly for a vehicle of claim 1 wherein the cover is continuous for covering the entire tire within it without gaps.

14. The spare tire assembly for a vehicle of claim 7 wherein said dimples are on the surface of the cover.

15. The spare tire assembly for a vehicle of claim 1 wherein the dimples are over the entire surface of the cover.

16. A spare tire assembly comprising:
a cover; and
a spare tire supported within said cover, wherein said cover has an aerodynamically enhanced outer surface for preventing direct wind contact with said spare tire.

17. The spare tire assembly of claim 16 further comprising the cover being injection molded from a recycled automotive regrind material.

18. The spare tire assembly of claim 16 further comprising:
an under mount frame for contacting said cover when said spare tire and cover are in a stowed position;
an actuator connected to said under mount frame; and
a support member connected between said actuator, said cover and said spare tire, wherein said actuator moves said support member and said cover member between said stowed position and a deployed position.

19. The spare tire assembly of claim 16 further comprising:
said cover includes a side wall for extending around the outer periphery of a spare tire and a circular portion attached to the side wall so that said aerodynamically enhanced outer surface is a continuous outer aerodynamic housing encompassing the entire tire within the cover;
at least one attachment strap attached across the wall in a radial manner for securing of the tire in the cover said at least one attachment strap allowing for securing and carry of the tire.

20. The spare tire assembly of claim 19 further comprising at least two straps radially attached to the side wall and crossing near the central portion of the cover.

21. The spare tire assembly of claim 16 further comprising a square-sided cover having a D-shaped cover for improving airflow under the vehicle.

22. The spare tire assembly of claim 16 wherein said cover further comprises a fairing cover having a flange portion extending under a bumper of the vehicle frame for preventing airflow between the fairing cover and the bumper.

23. The spare tire assembly of claim 22 wherein said fairing cover further comprises a fairing flange and said bumper further comprises a bumper flange wherein the portion of the fairing cover that extends under the bumper has said fairing flange for connecting said fairing flange to said bumper flange and providing further support to the fairing cover.
